(19) United States
(12) Patent Application Publication
(10) Pub. No.: US 2026/0160304 A1
(43) Pub. Date: Jun. 11, 2026

(54) CLUTCH PACK REACTOR PLATE

(71) Applicant: Schaeffler Technologies AG & Co. KG, Herzogenaurach (DE)

(72) Inventors: Erick Arturo Vazquez, Puebla (MX); Alfredo Jimenez Perez Mitre, Wooster, OH (US); Brian Zaugg, Millersburg, OH (US)

(73) Assignee: Schaeffler Technologies AG & Co. KG, Herzogenaurach (DE)

(21) Appl. No.: 19/413,972

(22) Filed: Dec. 9, 2025

Related U.S. Application Data
(60) Provisional application No. 63/730,229, filed on Dec. 10, 2024.

(51) Int. Cl. F16D 13/64

(52) U.S. Cl. CPC F16D 13/648

(57) ABSTRACT

A clutch pack reactor plate includes an annular ring. The annular ring includes a rotational axis, a toroidal surface facing a first axial direction, and a first annular surface, smaller than the toroidal surface, facing a second axial direction, opposite the first axial direction. A clutch pack including the clutch pack reactor plate is also disclosed.

### CROSS-REFERENCE TO RELATED APPLICATIONS

This application claims the benefit of U.S. Provisional Patent Application No. 63/730,229, filed Dec. 10, 2024, the disclosure of which is incorporated in its entirety by reference herein.

### TECHNICAL FIELD

The present disclosure relates generally to a clutch pack, and more specifically to a clutch pack reactor plate.

### BACKGROUND

Clutches are known from commonly-assigned United States Patent Application Publication No. 2012/0152680 titled MODIFIED FRICTION MEMBER FOR BALANCED UNIT LOADING to Vanni et al., hereby incorporated by reference as if set forth fully herein.

### SUMMARY

Example aspects broadly comprise a clutch pack reactor plate including an annular ring. The annular ring includes a rotational axis, a toroidal surface facing a first axial direction, and a first annular surface, smaller than the toroidal surface, facing a second axial direction, opposite the first axial direction. In an example embodiment, the toroidal surface and the first annular surface share an undulating outer profile. In an example embodiment, annular ring also includes an undulating surface connecting the toroidal surface to the first annular surface. In an example embodiment, an inner diameter of the toroidal surface is smaller than an inner diameter of the first annular surface.

In some example embodiments, the annular ring also includes a second annular surface, radially inside of the first annular surface, and a thickness of the clutch pack reactor plate between the second annular surface and the toroidal surface is greater than a thickness between the first annular surface and the toroidal surface. In an example embodiment, the annular ring also includes a third annular surface, radially inside of the second annular surface, and a thickness of the clutch pack reactor plate between the third annular surface and the toroidal surface is greater than a thickness between the second annular surface and the toroidal surface.

In an example embodiment, the annular ring also includes a third annular surface, and the toroidal surface and the third annular surface share a same inner diameter. In an example embodiment, the annular ring also includes a third annular surface and a circumferential surface connecting the toroidal surface and the third annular surface.

Other example aspects broadly comprise a clutch pack including the clutch pack reactor plate, a clutch plate contacting the toroidal surface, a clutch housing including a groove, and a snap ring arranged in the groove and contacting the first annular surface. In some example embodiments, the clutch pack also includes a plurality of clutch plates, and a plurality of separator plates interleaved with the plurality of clutch plates. In some example embodiments, each of the plurality of clutch plates is rotationally engaged with the clutch housing. In an example embodiment, the clutch pack reactor plate is rotationally engaged with the clutch housing.

In an example embodiment, each of the plurality of clutch plates includes a respective friction material ring, and each of the plurality of separator plates includes a respective friction material ring. In an example embodiment, the clutch pack also includes a piston, sealed to the clutch housing and arranged to contact a one of the plurality of clutch plates to compress the plurality of clutch plates and the plurality of separator plates against the clutch pack reactor plate. In an example embodiment, the clutch housing includes an inner spline and the clutch pack reactor plate includes an outer spline rotationally engaged with the inner spline.

### BRIEF DESCRIPTION OF THE DRAWINGS

FIG. 1 illustrates a perspective view of a clutch pack reactor plate according to an example embodiment.

FIG. 2 illustrates a cross-sectional view of the clutch pack reactor plate of FIG. 1.

FIG. 3 illustrates a detail view of boxed region 3 of FIG. 2.

FIG. 4 illustrates a cross-sectional view of a clutch pack including the clutch pack reactor plate of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

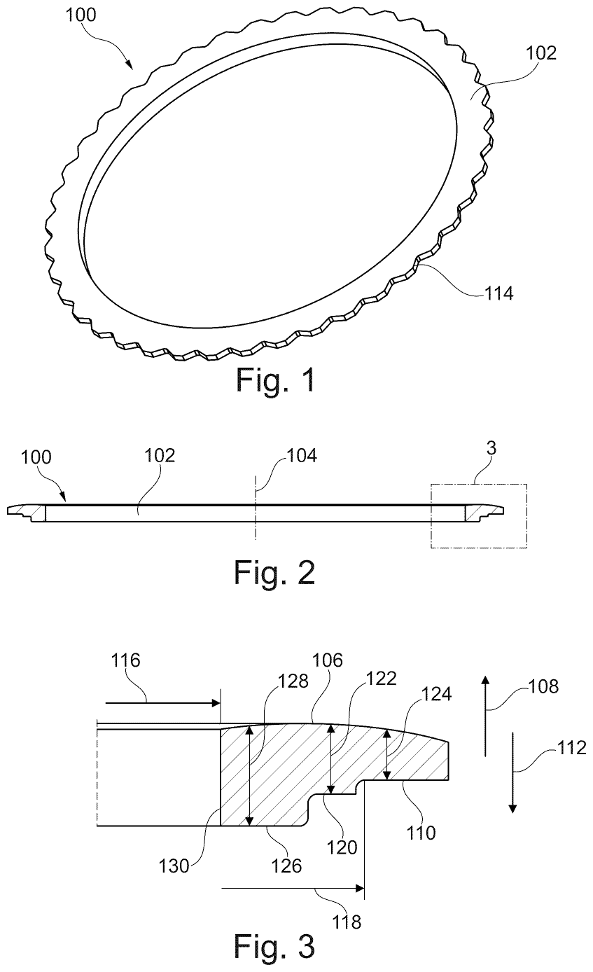

The following description is made with reference to FIGS. 1-3. FIG. 1 illustrates a perspective view of clutch pack reactor plate 100 according to an example embodiment. FIG. 2 illustrates a cross-sectional view of the clutch pack reactor plate of FIG. 1. FIG. 3 illustrates a detail view of boxed region 3 of FIG. 2. Clutch pack reactor plate 100 includes annular ring 102. The annular ring includes rotational axis 104, toroidal surface 106 facing axial direction 108, and annular surface 110 facing axial direction 112, opposite axial direction 108. By a toroidal surface, we mean a curved surface formed by revolving an arc from an ellipse or a circle, for example, around the rotational axis. By an annular surface, we mean a flat surface formed by revolving a line around the rotational axis. As can be seen in FIG. 3, for example, annular surface 110 is smaller than the toroidal surface. In other words, an area of the annular surface is less than an area of the toroidal surface.

As shown in FIG. 1, for example, toroidal surface 106 and annular surface 110 share an undulating outer profile. In other words, the clutch pack reactor plate also includes undulating surface 114 connecting the toroidal surface to annular surface 110. Inner diameter 116 of the toroidal surface is smaller than inner diameter 118 of annular surface 110. Clutch pack reactor plate 100 also includes annular surface 120, radially inside of annular surface 110. Thickness 122 of the clutch pack reactor plate between the annular surface 120 and the toroidal surface is greater than thickness 124 between the annular surface 110 and the toroidal surface.

Clutch pack reactor plate 100 also includes annular surface 126, radially inside of annular surface 120. Thickness 128 of the clutch pack reactor plate between the annular surface 126 and the toroidal surface is greater than thickness 122 between annular surface 120 and the toroidal surface. Toroidal surface 106 and annular surface 126 share a same inner diameter (e.g., inner diameter 116). Circumferential surface 130 connects the toroidal surface and annular surface 126.

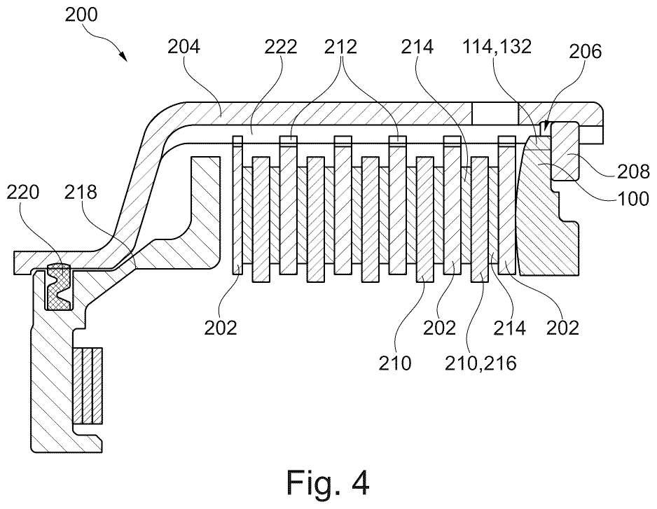

The following description is made with reference to FIG. 4. FIG. 4 illustrates a cross-sectional view of a clutch pack including the clutch pack reactor plate of FIG. 1. Clutch pack 200 includes clutch pack reactor plate 100, clutch plate 202 contacting the toroidal surface, clutch housing 204 including groove 206, and snap ring 208 arranged in the groove and contacting annular surface 110. Clutch pack 200 includes several clutch plates 202 and several separator plates 210 interleaved with clutch plates. Although a particular number of clutch plates and separator plates are shown, other quantities of clutch plates and separator plates are possible.

The clutch plates are rotationally engaged with the clutch housing at respective tooth portions 212, for example. Clutch pack reactor plate 100 is rotationally engaged with the clutch housing via undulating surface 114, for example. Each of the clutch plates and separator plates includes a respective friction material ring 214. Other embodiments may include a pair of friction material rings 214 on opposite axial sides of a steel backing plate 216.

Clutch pack 200 also includes piston 218, sealed to the clutch housing via seal 220, for example, and arranged to contact one of the clutch plates 202 to compress the clutch plates and the separator plates against the clutch pack reactor plate. Clutch housing 204 includes inner spline 222 and clutch pack reactor plate 100 includes outer spline 132 rotationally engaged with the inner spline. Undulating surface 114 may form outer spline 132, for example.

The effect of having a reactor plate with a dome (or toroidal shape) is that unit loading of the friction material is optimized. In other words, the whole surface is in contact at every pressure and there is no delta unit loading on the surface. This results from a self alignment due to the tilt of the reactor plate so that the surface pressures of the friction material rings are evenly distributed. This feature not only improves durability by optimizing the unit loading, but may also eliminate shudder caused by over compression of the paper during the actuation cycle, since the lower unit pressure maintains an oil film across the friction surface.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Clutch pack reactor plate
102 Annular ring
104 Rotational axis
106 Toroidal surface
108 Axial direction (first)
110 Annular surface (first)
112 Axial direction (second)
114 Undulating surface
116 Inner diameter (toroidal surface)
118 Inner diameter (first annular surface)
120 Annular surface (second)
122 Thickness (second annular surface to toroidal surface)
124 Thickness (first annular surface to toroidal surface)
126 Annular surface (third)
128 Thickness (third annular surface to toroidal surface)
130 Circumferential surface
132 Outer spline
200 Clutch pack
202 Clutch plate
204 Clutch housing
206 Groove
208 Snap ring
210 Separator plate
212 Tooth portions (clutch plates)
214 Friction material ring (separator plate)
216 Backing plate (separator plate)
218 Piston
220 Seal (piston to housing)
222 Inner spline (clutch housing)

What is claimed is:

1. A clutch pack reactor plate, comprising:
an annular ring comprising:
a rotational axis;
a toroidal surface facing a first axial direction; and
a first annular surface, smaller than the toroidal surface, facing a second axial direction, opposite the first axial direction.

2. The clutch pack reactor plate of claim 1, wherein the toroidal surface and the first annular surface share an undulating outer profile.

3. The clutch pack reactor plate of claim 1, wherein the annular ring further comprises an undulating surface connecting the toroidal surface to the first annular surface.

4. The clutch pack reactor plate of claim 1, wherein an inner diameter of the toroidal surface is smaller than an inner diameter of the first annular surface.

5. The clutch pack reactor plate of claim 1, wherein:
the annular ring further comprises a second annular surface, radially inside of the first annular surface; and
a thickness of the clutch pack reactor plate between the second annular surface and the toroidal surface is greater than a thickness between the first annular surface and the toroidal surface.

6. The clutch pack reactor plate of claim 5, wherein:
the annular ring further comprises a third annular surface, radially inside of the second annular surface; and
a thickness of the clutch pack reactor plate between the third annular surface and the toroidal surface is greater than a thickness between the second annular surface and the toroidal surface.

7. The clutch pack reactor plate of claim 1, wherein:
the annular ring further comprises a third annular surface; and
the toroidal surface and the third annular surface share a same inner diameter.

8. The clutch pack reactor plate of claim 1, wherein the annular ring further comprises:
a third annular surface; and
a circumferential surface connecting the toroidal surface and the third annular surface.

9. A clutch pack, comprising:
the clutch pack reactor plate of claim 1;
a clutch plate contacting the toroidal surface;
a clutch housing comprising a groove; and
a snap ring arranged in the groove and contacting the first annular surface.

10. The clutch pack of claim 9, further comprising:
a plurality of clutch plates; and
a plurality of separator plates interleaved with the plurality of clutch plates.

11. The clutch pack of claim 10, wherein each of the plurality of clutch plates is rotationally engaged with the clutch housing.

12. The clutch pack of claim 11, wherein the clutch pack reactor plate is rotationally engaged with the clutch housing.

13. The clutch pack of claim 10 wherein:
each of the plurality of clutch plates comprises a respective friction material ring; and
each of the plurality of separator plates comprises a respective friction material ring.

14. The clutch pack of claim 10, further comprising a piston, sealed to the clutch housing and arranged to contact a one of the plurality of clutch plates to compress the plurality of clutch plates and the plurality of separator plates against the clutch pack reactor plate.

15. The clutch pack of claim 9, wherein:
the clutch housing comprises an inner spline; and
the clutch pack reactor plate comprises an outer spline rotationally engaged with the inner spline.
